(19) United States
(12) Patent Application Publication
(10) Pub. No.: US 2013/0287924 A1
(43) Pub. Date: Oct. 31, 2013

(54) COCOA POWDER COMPOSITIONS

(71) Applicants: Erik Paul Alosin Berenschot, Zaandijk (NL); Nynke Elisabeth Hopmans, Medemblik (NL)

(72) Inventors: Erik Paul Alosin Berenschot, Zaandijk (NL); Nynke Elisabeth Hopmans, Medemblik (NL)

(73) Assignee: Cargill ,Incorporated, Wayzata, MN (US)

(21) Appl. No.: 13/979,291

(22) PCT Filed: May 9, 2011
(86) PCT No.: PCT/EP2011/002298

§ 371 Date: Jul. 11, 2013

(30) Foreign Application Priority Data
Jan. 12, 2011 (EP) 11000198.9

(51) Int. Cl. A23G 1/32

(52) U.S. Cl. CPC A23G 1/32
USPC 426/593; 426/631

(57) ABSTRACT

A defatted cocoa powder composition which is dispersible in cold liquids and method of producing and using the same.

### FIELD OF THE INVENTION

The present invention relates to instant cocoa powder compositions for use in the preparation of beverages and/or foodstuffs. In particular, the invention relates to compositions which have good wettability and dispersibility in cold liquids.

### BACKGROUND OF THE INVENTION

Cocoa powder, typically containing 10-26% fat, is used in the food industry for a variety of applications, including confectionery, bakery, frozen desserts and beverages. In the beverage industry, it is mixed with sugar and used to produce compositions for both hot and cold beverages. Unfortunately, this results in products which are deemed to be highly calorific and there has therefore been a long felt need for healthier cocoa-based beverages.

This could be achieved by reducing the sugar content. Unfortunately, however, such modifications have, in the past, lead to a critical decrease in dispersibility of the cocoa powder compositions, especially in cold liquids. It is indeed desirable that such compositions should wet out and disperse rapidly into cold (e.g. refrigerated) milk or water, producing a beverage which has a smooth texture (mouth-feel), which is uniform in appearance and which is stable for at least several minutes while the beverage is being consumed. Unfortunately, when low-sugar cocoa powder compositions are added to cold liquids a number of undesirable phenomena are observed, including the formation of floating lumps (“lumping”) at the liquid's surface due to poor wetting and excessive sedimentation of cocoa powder aggregates, leading to an overall undesirable sensory experience and limiting the product's application in key sectors such as for the production of milkshakes and chocolate milk drinks.

To date, this problem has been addressed by adding wetting agents such as oil and fat compositions or silica to the cocoa powder compositions (see JP2005110593 or U.S. Pat. No. 4,016,337 for example). This is, however, considered undesirable from a consumer perspective. It is indeed the case that consumers are increasingly seeking to reduce the quantity of additives in their diets. An alternative solution—the use of high levels of emulsifiers such as lecithin—has also been proposed. Indeed, most major cocoa producers sell “lecithinated cocoa powders” but these still take more than two minutes to wet out and disperse in cold water. Increasing the lecithin level does not improve dispersibility but will lead to stickiness and handling problems which, in turn, can result in the formation of difficult-to-disperse lumps.

As can be seen from the foregoing discussion, there is still a need in the art for a lower-calorie cocoa powder composition which has satisfactory dispersibility in cold liquids. The present invention provides such a composition.

### SUMMARY OF THE INVENTION

According to a first aspect of the present invention, there is provided a cold dispersible cocoa powder composition comprising (a) a defatted cocoa powder; and (b) 30-75% bulking sugar by weight.

According to another aspect of the present invention, there is provided a process for producing a dispersible cocoa powder composition comprising the step of: mixing a defatted cocoa powder and/or a defatted cocoa cake with 30-75% bulking sugar by weight.

According to a further aspect of the present invention, there is provided a beverage and/or foodstuff comprising—or produced with—such a composition.

According to yet another aspect of the present invention, there is provided the use of a defatted cocoa powder to increase the dispersibility of a cocoa powder composition having a low bulking sugar content.

### DETAILED DESCRIPTION

The present invention provides a dispersible cocoa powder composition comprising cocoa powder and a bulking sugar.

### Cocoa Powder

The cocoa powder may be from any source and processed according to any methods known in the art (e.g. to improve taste, texture and/or appearance). It may, for instance, be tempered to obtain a tempered cocoa powder, alkalized or dutched to improve color and/or flavor, or milled to obtain a finer or more uniform composition. Preferably, the cocoa powder will have an average particle size of 2-100 microns, more preferably of 5-50 microns, more preferably of 5-20 microns. According to one particular embodiment, the cocoa powder will have an average particle size of 8-12 microns.

Importantly, the cocoa powder will be a defatted cocoa powder. Typically, cocoa powders contain 10-12% cocoa butter by weight. Cocoa powders are described as “low-fat cocoa powders” as soon as they have a cocoa butter content below 10% by weight. Cocoa butter content can be reduced using any known method. A suitable method is described in WO2004/034801 (Cargill, Incorporated). Cocoa powders suitable for use in the present invention will preferably have a cocoa butter content of 5% by weight or less, more preferably of 2% by weight or less, more preferably of 1% by weight or less. According to a particular embodiment, the cocoa powders will be substantially fat-free. Advantageously, fat-free cocoa powders will not need to be tempered.

Cocoa powder is included in the present composition in an amount of 25 to 70% by weight, preferably in an amount of 30 to 60% by weight, even more preferably in an amount of 40-60% by weight, based on total dry weight of the composition. According to one possible embodiment, the composition will comprise approximately 30% cocoa powder by weight.

### Bulking Sugar

The term “bulking sugar” as used herein refers to sugars suitable for use as bulking agents in the preparation of food or beverage compositions. They may also be used to increase the sweetness of the final product. Suitable examples of bulking sugars include, but are not limited to: sucrose, fructose, dextrose, maltodextrin, polydextrose and mixtures of two or more thereof. Alternatively, low calorie or calorie free sweeteners can be used, if necessary in combination with additional, ideally flavorless, bulking agents. Preferably, the bulking sugar will be sucrose and/or dextrose. It may be present in a crystalline, powder or liquid form (e.g. in the form of a syrup or of sugar pre-dissolved in water). Preferably a fine or extra fine crystalline sugar will be used. Alternatively, powdered sugars (of the “icing sugar” type) may be used.

Bulking sugars have traditionally been used in amounts of 80% or more by weight based on the total weight of the cocoa powder composition. This has been necessary to achieve a minimum level of dispersibility. Nonetheless, dispersibility in cold liquids has remained unsatisfactory. It has now surprisingly been found that, with the present invention, a satisfactory level of dispersibility can be achieved, even in cold liquids, with bulking sugar levels below 80% by weight. Thus, the cocoa powder compositions of the present invention will comprise only 30-75% bulking sugar by weight. Preferably, they will comprise 40-70%, more preferably 40 to 60%, bulking sugar by weight. For low calorie applications, it will be preferred to use less than 40% bulking sugar by weight.

### Cold Dispersibility

The expressions “cold dispersible” and “dispersible in cold liquids” as used herein refer to the fact that the compositions of the present invention are capable of being completely (or substantially completely) dispersed in a cold liquid in a relatively short time frame. Cold liquids will be understood to be liquids (such as water or milk) maintained at room temperature or below and, in particular, refrigerated liquids (having a temperature of about 5-7° C.). Dispersibility can be assessed using a number of criteria including: wettability (if and how quickly a composition sinks through the surface of a liquid), lumping (if and how much of the composition remains on the liquid's surface after simple manual stirring) and sedimentation (the rate at which the composition sinks to the bottom of the liquid after stirring).

The cocoa powder compositions of the present invention will advantageously have a shorter wettability time than equivalent compositions in which the cocoa powder has either a standard or a high cocoa butter content (i.e. a cocoa butter content of 10% or more by weight). Ideally, the compositions of the present invention will have a wettability, measured according to Method 1, of less than 30 seconds, although for certain applications, a wettability of up to 90 seconds would still be a significant improvement. According to certain preferred embodiments, they will have a wettability of less than 20 seconds. When added to cold milk, the compositions will preferably be characterized by a substantial absence of lumping and a very slow rate of sedimentation (preferably, only a very small amount of composition will have sedimented 10 seconds after stirring).

### Emulsifier

Although it will not be necessary, according to certain embodiments, it may be desirable for the composition of the present invention to include one or more emulsifiers. Although any known emulsifier can be used (provided, of course, that it is safe for human consumption), it will be preferred to use a lecithin such as soy or sunflower lecithin.

When used, the composition will advantageously include the at least one emulsifier in an amount of no more than 15% by weight, preferably of no more than 10% by weight, more preferably of between 1 and 8% by weight, more preferably of between 2 and 7% by weight and, according to one particular embodiment, of between 2.5 and 6% by weight based on total dry weight of the cocoa powder.

### Other Ingredients

In addition to the one or more emulsifiers, the composition of the present invention may also include one or more additional, optional ingredients. These may include, by way of example only, stabilizers, additional bulking agents, coloring agents, flavoring agents, milk solids, vitamins, polyphenols, nutraceuticals and so on. The requirement for and choice of such additional ingredients will be readily determined by a person skilled in the art depending, in particular, on the desired end use of the composition.

Notably, dispersibility of the present compositions will not depend on the use of so-called wetting agents. Wetting agents are compositions which are added to a cocoa powder to improve its wettability. They include compositions such as fatty acid esters (see JP2005168366 from Morinaga & Co. or JP2005110593 from Riken Vitamin Co.) or certain polyol compositions, but do not include emulsifiers. As such, the composition of the present invention will preferably be free of such wetting agents. In particular, the defatted cocoa powder will not need to be—and will therefore preferably not be—coated with a wetting agent. Specifically excluded from the scope of the present invention is a cocoa powder composition (and any sweetened cocoa powder compositions produced therefrom) characterized in that it comprises, on a dry weight basis, 75-95% cocoa powder and 0.5-20% of at least one hydrophilic agent, wherein the cocoa powder is coated with the at least one hydrophilic agent and wherein the hydrophilic agent is preferably selected from one or more polyols and/or one or more sugars.

### Process

A process for producing a dispersible cocoa powder composition is also part of the present invention. In particular, the present invention provides a process for producing a dispersible cocoa powder composition comprising the step of: mixing a defatted cocoa powder and/or a defatted cocoa cake with 30-75% bulking sugar by weight.

The term “cocoa powder” is defined above. The term “cocoa cake”, by contrast, refers to an unprocessed form of cocoa powder. By way of background information, cocoa nibs are ground to produce a cocoa liquor which is then pressed to extract cocoa butter, leaving the cocoa cake. The cake is milled and optionally sieved to produce cocoa powder. The process of the present invention may use cocoa powder or cocoa cake as a starting material in the production of the final cocoa powder compositions. It will of course be understood by the skilled person that mixtures of cocoa powder and cocoa cake may also be used.

The term “mixing” may refer, for example, to simple mechanical mixing (e.g. with a paddle, disc, pin or knife mixer), to granulation (i.e. mixing of the cocoa powder with a wetted bulking sugar, for example a bulking sugar mixed with approximately 5% water based on total dry weight of the composition), to homogenization (e.g. in a high-shear mixer), to agglomeration or any other mixing or blending methods known to those skilled in the art. According to certain embodiments, it may be preferred to use agglomeration.

Agglomeration is a technique which is well known and routinely used in the art. According to one particular embodiment, it will consist of mixing the defatted cocoa powder and/or cocoa cake with bulking sugar in the form of a powder (e.g. of the icing sugar type) and subjecting the obtained mixture to a curtain of steam.

As noted above, the dispersible compositions of the present invention may also comprise one or more emulsifiers. As such, the above method may also include the step of adding one or more emulsifiers to the composition. Although the emulsifier(s) may be added both before and/or after the step of mixing the cocoa powder and/or cocoa cake with the bulking sugar, it will preferably be added to and blended with the cocoa powder and/or cocoa cake before introducing the bulking sugar. Methods of blending emulsifiers into cocoa powder are well known in the art and any such known method may be used. Preferably, the one or more emulsifiers will be added to and blended with the cocoa powder and/or cocoa cake at a temperature in the range of 20 to 100° C., more preferably at a temperature above 50° C., for instance, in the range of 60 to 100° C. Advantageously, it will be added/blended at a temperature above 75° C. such as at a temperature in the range of 80 to 100° C. According to particular embodiments, it will be added/blended at a temperature of about 60° C. or about 90° C. Mixing will be preferably be performed in such a way that the cocoa powder will be coated with the one or more emulsifiers.

Other steps that may be included in the method of the present invention will be apparent to a person skilled in the art. For example, the method may include one or more drying steps, cooling steps and/or tempering steps. It may also include one or more milling and/or sieving steps.

Milling (or grinding) can be achieved using any means known in the art, preferably under standard cocoa processing parameters. Ideally, the milling step will be used to achieve the desired average particle size defined above. Milling may be performed on the defatted cocoa powder and/or cocoa cake, before addition of the bulking sugar and/or it may be performed after addition of the bulking sugar. For example, a milling step may be used after agglomeration. Sieving will preferably be carried out after milling (if used) with a 0.1 to 2.0 mm sieve.

The process of the invention may also include the addition of one or more further optional ingredients as defined above (e.g. flavoring agents). The addition of such additional ingredients may be performed at any stage in accordance with normal practice in the industry.

Compositions obtained by the above method, and food or beverage compositions to which they may be added or in which they are included, are also part of the present invention.

### Beverages and Foodstuffs

Although the present composition can be used in the preparation of any conceivable type of beverage and/or foodstuff, it will be particularly suited for use in the preparation of beverages and/or foodstuffs which are dependent upon the satisfactory dispersion of a dry powder in a cold liquid. Examples of such products may include, without limitation, chocolate milk and other milk-based drinks, flavored yogurt drinks, milkshakes, sauces, infant formulas, creams, icings, mousses and whipped or “instant” desserts. Of course, the composition of the present invention may also be used in the preparation of hot beverages and/or foodstuffs such as hot chocolate drinks or sauces. The compositions of the present invention, which are produced with defatted cocoa powder and with a lower sugar content than usual, will be particularly desirable for use in the production of healthy and/or low- or reduced-calorie products.

The use of a defatted cocoa powder to increase the dispersibility of a cocoa powder composition having a low sugar content, especially in cold liquids (as compared to the same compositions prepared with standard cocoa powders) is also a part of the present invention, various embodiments of which are described in more detail in the following, non-limiting examples.

### EXAMPLES

### Methods for Assessing Dispersibility

Method 1: Wettability

150 ml of sterilized skimmed milk at 7° C. is poured into a beaker. 15 grams of a selected cocoa powder or cocoa powder composition to be tested are gently poured onto the surface of the liquid. The experiment is carried out at room temperature, e.g. 25° C. The time it takes for the powder to completely sink below the surface of the liquid is recorded as wettability time and graded as listed in Table 1.

TABLE 1
Wettability (W)

| Grade | Time required for complete wetting |
|---|---|
| Very good | 0-30 seconds |
| Good | 31-60 seconds |
| Moderate | 61-120 seconds |
| Weak | 121-180 seconds |
| Poor | More than 180 seconds |

Method 2: Lumping and Sedimentation

Once wettability time has been recorded (or after 3 minutes have passed, whichever occurs first), the liquid is manually stirred with a small dessert spoon, 15 times clockwise and 15 times anti-clockwise. The liquid is then left to settle for 10 seconds and the quantity of powder still on the surface—also referred to as “floaters” or “lumping”—is estimated (in relation to the total amount of powder added). Finally, the beakers are placed on a mirror stand to determine how much powder has settled onto the bottom (“sedimentation”). Lumping and sedimentation are graded according to the criteria of Tables 2 and 3, respectively.

TABLE 2
Lumping (L)

| Grade | Description |
|---|---|
| 90-100% | All or nearly all powder remaining on the surface |
| 50-90% | More than half of the powder remaining on the surface |
| 20-50% | Substantial amount of powder remaining on the surface |
| 1-20% | Small to moderate amount of powder |
| | remaining on the surface |
| Less than 1% | No powder remaining on the surface |

TABLE 3
Sedimentation (S)

| Grade | Description |
|---|---|
| 90-100% | All or nearly all product at the bottom |
| 50-90% | More than half of the product at the bottom |
| 20-50% | Substantial amount of product at the bottom |
| 1-20% | Small to moderate amount of product at the bottom |
| Less than 1% | No product on the bottom |

### EXAMPLES

The following compositions were prepared by mechanical mixing:

TABLE 4

| Ingredients (wt %) | Ref 1 | Ref 2 | P1 | P2 |
|---|---|---|---|---|
| 10/12 Cocoa Powder | 100 | — | — | — |
| (Gerkens ™ DP70 cocoa powder*) | | | | |
| 10/12 lecithinated cocoa powder | — | 100 | — | — |
| (Gerkens ™ DP70W cocoa powder*) | | | | |
| Defatted Cocoa Powder | — | — | — | — |
| (0.6% cocoa butter) | | | | |
| Defatted Cocoa Powder | — | — | 100 | 95 |
| (0.6 wt % cocoa butter) | | | | |
| Soy Lecithin | — | — | — | 5 |

*from Cargill

For P2, the soy lecithin was simply mixed with the cocoa powder. The same lecithin was used as is used in the production of DP70W (10/12 cocoa powder with lecithin). The cocoa powder used in all the examples had an average particle size of approximately 8-12 microns. Mixing was performed at 60-65° C. in a Hobart-type mixer for 30 minutes.

Samples of the above products were then used, with varying amounts of bulking sugar (sucrose) to form both agglomerates and granulates as follows:
agglomerates were formed by mixing the samples with icing sucrose, milling the mixture at 0.5 mm and subjecting it to a curtain of steam. The resulting agglomerates were sieved and the 0.5-1 mm fraction was selected for wettability tests.
granulates were formed by mixing the samples with fine sucrose (with an average particle size of 0.35-0.55 mm) which is wetted with 5% water by weight based on the final composition. The sucrose is wetted and the cocoa powder sticks to the sucrose granules.

The wettability of both the agglomerates and the granulates in cold milk (7° C.) of these final compositions was then determined after at least 7 days storage at room temperature, using the Method 1 described above. Results for the agglomerates are shown in Tables 5 and 6. Results for the granulates are shown in Table 7.

TABLE 5
wettability of agglomerates with varying bulking sugar content

| Sugar | Sample | Ref. 1 | Ref. 2 | P1 |
|---|---|---|---|---|
| 80% | W | >180 s | 60 s | 15.4 s |
| (ref) | L | 50-90% | 1-20% | 0% |
| | S | 1-20% | 1-20% | 0% |
| 70% | W | >180 s | >180 s | 16.3 s |
| | L | 50-90% | 50-90% | 0% |
| | S | 1-20% | 1-20% | 0% |
| 60% | W | >180 s | >180 s | 64.7 s |
| | L | 50-90% | 50-90% | 0% |
| | S | 1-20% | 1-20% | 0% |

TABLE 6
wettability of agglomerates with varying bulking sugar content

| Sugar | Sample | Ref. 1 | Ref. 2 | P2 |
|---|---|---|---|---|
| 50% | W | >180 s | >180 s | 9.4 |
| | L | 50-90% | 50-90% | 0% |
| | S | 1-20% | 1-20% | 0% |
| 40% | W | >180 s | >180 s | 21.6 |
| | L | 50-90% | 50-90% | 0% |
| | S | 1-20% | 1-20% | 0% |

TABLE 7
wettability of granulates with varying bulking sugar content

| Sugar % | Sample | Ref. 1 | Ref. 2 | P1 |
|---|---|---|---|---|
| 80% | W | >180 s | >180 s | 15.4 s |
| (ref) | F | 50-90% | 50-90% | 0% |
| | S | 1-20% | 1-20% | 1-20% |
| 70% | W | >180 s | >180 s | 17.3 s |
| | F | 50-90% | 50-90% | 0% |
| | S | 1-20% | 1-20% | 1-20% |

As demonstrated by the above results, the compositions of the present invention not only have better dispersibility in cold liquids than standard cocoa powder alone, but also better dispersibility than standard cocoa powder when mixed with an emulsifier, whether prepared by granulation or agglomeration and even at lower bulking sugar concentrations.

The above examples of the compositions of the present invention and methods for preparing them is not intended to be exhaustive or limiting but are merely included for illustrative purposes. Various equivalent modifications are possible within the scope of the invention, as those skilled in the art will recognize. The teachings of the present invention are applicable to other powder compositions. They may not be limited to the compositions and methods described above.

1.-11. (canceled)

12. A cold dispersible cocoa powder composition comprising:
a defatted cocoa powder; and
30-75% bulking sugar by weight.

13. The composition of claim 12, wherein the composition has a wettability of less than 30 seconds, the wettability measured according to Method 1.

14. The composition of claim 12, wherein the defatted cocoa powder has an average particle size of 2-100 microns.

15. The composition of claim 12, wherein the defatted cocoa powder has a cocoa butter content of 5% by weight or less.

16. The composition of claim 12, wherein the defatted cocoa powder is substantially fat-free.

17. The composition of claim 12, the composition comprising 40-70% bulking sugar by weight.

18. The composition of claim 12, wherein the bulking sugar comprises a sugar selected from the group consisting of sucrose, dextrose, and mixtures thereof.

19. The composition of claim 12, further comprising an emulsifier.

20. The composition of claim 19, wherein the emulsifier comprises lecithin.

21. The composition of claim 12, wherein the defatted cocoa powder is not coated with a hydrophilic agent.

22. A process for producing a dispersible cocoa powder composition, the process comprising:
mixing a defatted cocoa powder or a defatted cocoa cake with 30-75% bulking sugar by weight.

23. The process of claim 22, wherein the dispersible cocoa powder composition has a wettability, measured according to Method 1, of less than 30 seconds.

24. The process of claim 22, further comprising a milling step.

25. The process of claim 24, wherein the milling step comprises milling the defatted cocoa powder or defatted cocoa cake to an average particle size of 2-100 microns.

26. The process of claim 22, wherein the defatted cocoa powder has a cocoa butter content of 5% by weight or less.

27. The process of claim 22, wherein the defatted cocoa powder or the defatted cocoa cake is mixed with 40-70% bulking sugar by weight.

28. The process of claim 22, wherein the bulking sugar comprises a sugar selected from the group consisting of sucrose, dextrose, and mixtures thereof.

29. The process of claim 22, further comprising adding an emulsifier.

30. A beverage or foodstuff comprising the composition of claim 12.

31. A beverage or foodstuff comprising the composition obtainable according to the process of claim 22.
